(19) United States
(12) Patent Application Publication
(10) Pub. No.: US 2025/0249446 A1
(43) Pub. Date: Aug. 7, 2025

(54) DOSING MODULE WITH ACTUATING WINDOW

(71) Applicant: BioFluidix GmbH, Freiburg (DE)

(72) Inventors: Andreas ERNST, Bollschweil (DE); Nils LASS, Oberkirch (DE)

(73) Assignee: BioFluidix GmbH, Freiburg (DE)

(21) Appl. No.: 19/189,247

(22) Filed: Apr. 24, 2025

Related U.S. Application Data
(63) Continuation of application No. PCT/EP2023/078044, filed on Oct. 10, 2023.

(30) Foreign Application Priority Data
Oct. 25, 2022 (DE) 102022211313.6

(51) Int. Cl. B01L 3/02

(52) U.S. Cl. CPC B01L 3/0241; B01L 3/021; B01L 2300/0896; B01L 2400/0481

(57) ABSTRACT

A dosing module for use in a dosing system configured to dispense droplets at an outlet opening of the nozzle tube by deformation of a nozzle tube is provided. The dosing module includes a bracket and a nozzle tube which is fastened to the bracket and has the outlet opening. The bracket includes an actuation window which penetrates the bracket and in which a radially elastic portion of the nozzle tube is exposed, wherein portions of the nozzle tube spaced apart from each other in the longitudinal direction of the nozzle tube are fixed by portions of the bracket arranged on opposite sides of the actuating window.

### CROSS-REFERENCE TO RELATED APPLICATIONS

This application is a continuation of copending International Application No. PCT/EP2023/078044, filed Oct. 10, 2023, which is incorporated herein by reference in its entirety, and additionally claims priority from German Application No. 10 2022 211 313.6, filed Oct. 25, 2022, which is also incorporated herein by reference in its entirety.

### TECHNICAL FIELD

The present invention relates to devices and methods for dispensing one or more droplets from a dosing system and, in particular, to devices and methods for a dosing module having a bracket which includes an actuating window.

### BACKGROUND OF THE INVENTION

Microfluidics deals with the handling of liquids in the femtoliter to milliliter range. Small components (e.g. a thin tube with a small hole diameter) are used to dispense liquids in such small quantities without contact, which are susceptible to unintended mechanical influences (e.g. crushing). The production of small, free-flying droplets requires sufficient energy transfer to separate the desired volumes from a liquid column or to detach them from their production structure. These components can be easily deformed and damaged, but they should be able to be precisely and reproducibly inserted into a dosing module and deformed in it for droplet dispensing. The components can include a nozzle tube (e.g. an elastic hose), which can receive a fluid and dispense at least a part of the fluid from an outlet opening upon deformation by an actuator.

The correct insertion of the nozzle tube into a dosing system can be complicated and cumbersome, and can affect the precision of the droplet dispensing. Furthermore, an incorrect arrangement of the nozzle tube in the dosing system can lead to damage during subsequent use (e.g. in the case of deformation by an actuator). For example, a dosing system with an interchangeable nozzle tube can comprise a guide groove, into which the nozzle tube is to be inserted and is then to be covered with a flat plate and held in place. With such a dosing system, an incorrectly oriented nozzle tube can protrude from the guide groove and can be crushed by the flat plate. Furthermore, a discrepancy between dimensions of the nozzle tube and the guide groove can result in excessive pre-deformation of the nozzle tube or a clearance between the nozzle tube and the guide groove. This can reduce the precision of the nozzle tube (e.g. in terms of dispensing quantity and direction).

Document US 2006/0147313 A1 discloses a microdosing device with a flexible polymer tube, from which liquid can be dispensed by means of a displacer as free-flying droplets or as a free-flying jet (primarily in the nanoliter to picoliter range).

U.S. Pat. No. 11,148,164 B2 discloses a dosing device with a capillary tube which can be deformed by a piezoelectric actuator, wherein the capillary tube is interchangeable.

It is an object of the invention to provide a dosing module and a method which are intended to simplify operation, improve precision and reduce the risk of damage to a nozzle tube or at least improve a compromise of these objects.

### SUMMARY

According to an embodiment, a dosing module for use in a dosing system configured to dispense droplets at an outlet opening of a nozzle tube by deformation of the nozzle tube may have: a bracket, and a nozzle tube which is fastened to the bracket and has the outlet opening, wherein the bracket has: an actuation window which penetrates the bracket and in which a radially elastic portion of the nozzle tube is exposed, wherein portions of the nozzle tube spaced apart from each other in the longitudinal direction of the nozzle tube are fixed by portions of the bracket arranged on opposite sides of the actuation window.

According to another embodiment, a dosing system may have: a dosing module as mentioned above; a holding module configured to hold the dosing module on a first side; and an actuator module configured to hold the dosing module on a side opposite the first side, and having an actuator configured to cause a deformation of the nozzle tube to dispense droplets at an outlet opening of the nozzle tube, wherein the dosing module and at least one of the holding module and the actuator module are separate modules configured, in an operating state, to be coupled to each other and to be separated from each other again.

According to another embodiment, a method for dispensing a droplet from a dosing system as mentioned above may have the steps of: providing the dosing module with a portion, of the holding module and the actuator module; coupling the dosing module to the actuator module and the holding module, wherein the portion of the dosing module is arranged between the actuator module and the holding module; actuating the actuator module, in order to eject one or more droplets from the outlet opening of the nozzle tube; and disconnecting the dosing module at least from the actuator module.

Examples provide a dosing module comprising: a bracket, and a nozzle tube which is fastened to the bracket and comprises the outlet opening. The bracket includes an actuation window which penetrates the bracket and in which a radially elastic portion of the nozzle tube is exposed, wherein portions of the nozzle tube spaced apart from each other in the longitudinal direction of the nozzle tube are fixed by portions of the bracket arranged on opposite sides of the actuating window.

Since the nozzle tube is fixed to two portions of the bracket, the nozzle tube has a fixed position and orientation with respect to the bracket. The bracket is more stable and thus allows indirect handling of the nozzle tube with reduced risk of damaging the nozzle tube. The bracket can be aligned with other components with less effort compared to the nozzle tube (for example, by placing, inserting, snapping into or onto the components, or aligning on the basis of marks). The nozzle tube can be indirectly fastened to other components by the bracket, without the need to clamp in the nozzle tube directly. The actuation window allows the nozzle tube to be deformed to expel liquids in it. Therefore, the bracket allows the risk of damage to the nozzle tube to be reduced, but also allows access to the nozzle tube in order to deform it. The penetrating actuation window allows access to the nozzle tube from both sides. Thus, an actuator can actuate the nozzle tube from one side, and a counterstructure which can interact with the actuator for the deformation of the nozzle tube can be applied from another side. The penetrating actuation window allows counterstructures of different dimensions to be received. The dosing module therefore comprises improved compatibility with such differently formed counterstructures (e.g. of a dosing system and/or a holding module). Since the actuation window allows counterstructures to be received, it is not necessary for the dosing module itself to provide the counterstructure. For example, the same counterstructure (e.g. of a dosing system) can thus be reused for different dosing modules (e.g. to provide new nozzle tubes). For these different dosing modules, there is no need to produce a separate counterstructure and then dispose of it. The dosing module can therefore improve cost efficiency and resource utilization.

The nozzle tube can comprise a smaller dimension than the bracket in the direction in which the actuation window penetrates the bracket, with the result that the nozzle tube is recessed with respect to at least one surface of the bracket, in which the actuation window is formed. By recessing the nozzle tube with regard to the surface of the bracket, the bracket reduces the risk of deforming the nozzle tube outside the actuating window. Therefore, the risk is reduced that a liquid dispensing rate of the nozzle tube is different from an expected value due to a deformation beyond the actuating window.

The bracket can further include a fluid inlet opening which is fluidically coupled to the nozzle tube. Especially in the area of microfluidics, the diameter of the nozzle tube can be so small that filling with liquid and/or coupling to a fluid reservoir are/is complicated. However, since the nozzle tube is already fixed to the bracket, the fluid inlet opening of the bracket can already be fluidically connected to the nozzle tube. The fluid inlet opening can therefore be of different dimensions (beyond the fluidic connection) than the nozzle tube.

The fluid inlet opening can comprise a larger flow cross section than the nozzle tube. The larger flow cross section allows easier coupling to a fluid reservoir and/or introduction of a liquid. In addition, the larger flow cross section can be realized by a standard inlet opening (e.g. of the Luer system).

A flow direction perpendicular to the flow cross section of the fluid inlet opening can be arranged at an angle with respect to the longitudinal direction of the nozzle tube. The fluid inlet opening can thus be connected to a fluid reservoir provided on the side of the dosing module (e.g. on a holding module or an actuator module). The dosing module therefore does not have to be able to support the weight of the fluid reservoir and can therefore be of more compact shape.

The bracket can comprise a plate-shaped first portion, in which the nozzle tube and the actuation window are arranged, and a second portion, in which the fluid inlet opening is arranged, wherein the second portion can protrude from the first portion radially with respect to the nozzle tube. The separation into two portions which fulfill two different functions (providing the actuation window and providing the fluid inlet opening) allows independent dimensioning of the two portions. The first portion can thus be of flat and compact dimensions, and the second portion can be dimensioned according to the dimensions of the fluid inlet opening.

First guidance structures may comprise for engagement with matching second guidance structures of a holding module and/or third guidance structures of an actuator module. The guidance structures make it easier for the user to arrange the modules correctly with respect to each other. Since the bracket of the dosing module comprises the actuating window, the elastic portion of the nozzle tube received therein is also arranged correctly with respect to the holding module and/or actuator module as a result.

Examples provide a dosing system comprising: a dosing module as described herein; a holding module configured to hold the dosing module on a first side; and an actuator module configured to hold the dosing module on a side lying opposite the first side, and comprising an actuator configured to cause a deformation of the nozzle tube to dispense droplets at an outlet opening of the nozzle tube, wherein the dosing module and at least one of the holding module and the actuator module are separate modules configured, in an operating state, to be coupled to each other and to be separated from each other again.

The dosing system includes a holding module and an actuator module, wherein the holding module is configured to hold the dosing module and can make use of the ability to hold the nozzle tube indirectly via the bracket, and the actuator module can make use of the ability to deform the nozzle tube via the actuating window. Since the nozzle tube is fixed to the bracket, the holding module and the actuator module can be configured in such a way that the holding module the actuation window is arranged at the level of the actuator. Therefore, the actuator can deform the nozzle tube precisely and reproducibly. Furthermore, the nozzle tube can be fixed with respect to the actuator module without having to be fastened directly to the actuator module in a frictionally locking manner (e.g. in a retaining channel). The risk of excessive deformation or lack of fastening in the retaining channel is therefore reduced. Consequently, the accuracy of liquid dispensing is improved, and the requirements for accuracy in the manufacture of the nozzle tube are reduced.

The actuation window can be formed in a plate-shaped portion of the dosing module, wherein the holding module can comprise a receiving portion configured to receive the plate-shaped portion at least partially in the operating state. The receiving of the plate-shaped portion in the receiving portion allows, for example, by applying surfaces, edges or self-centering structures of the plate-shaped portion and/or the receiving portion, for the plate-shaped portion and thus also the nozzle tube to be oriented in a predefined manner with respect to the dosing module. This facilitates the coupling of the dosing module and the holding module and reduces the risk of incorrect arranging and/or orienting of the nozzle tube with respect to the holding module.

The receiving portion can comprise lateral walls, arranged in the operating state on opposite sides of the plate-shaped portion of the dosing module, and a rear wall, arranged in the operating state on that side of the dosing module facing away from the actuator module. Since the lateral walls are arranged on opposite sides, the lateral walls can define a position along a direction that extends between the lateral walls when the dosing module is received. When the dosing module is in contact, the rear wall allows predefined positioning of the dosing module in a direction perpendicular with respect to the rear wall. The receiving portion therefore allows the user to correctly arrange the dosing module with respect to the holding module in these two directions.

The bracket can comprise a portion which protrudes from the plate-shaped portion, in which the fluid inlet opening is arranged, and which protrudes radially with respect to the nozzle tube from the first portion, wherein, in the operating state, the protruding portion protrudes beyond an edge of the holding module, which is arranged in the longitudinal direction on that side of the holding module which faces away from the nozzle opening. The protruding portion protrudes beyond the edge of the holding module in the operating state and can provide more space there for larger components (such as a fluid inlet opening with a larger cross section). Furthermore, the protruding portion can bear against the holding module and thus define the position of the nozzle tube with respect to the holding module.

The dosing module can comprise first guidance structures and the holding module can comprise matching second guidance structures configured to engage with the first guidance structures and to move the holding module and the dosing module into a mechanically defined position with respect to each other. The first and second guidance structures can be dimensioned in such a way that, when the holding module and the dosing module are engaged, they are guided into a predetermined position and arranged with respect to each other. By engaging the first and second guidance structures, a user can correctly orient the dosing module and thus also the nozzle tube with respect to the holding module.

The actuator module can comprise third guidance structures configured to interact with the first and/or second guidance structures in order to move the actuator module, the dosing module and the holding module into a mechanically defined position with respect to each other. In the mechanically defined position, the actuator of the actuator module can be arranged with respect to the actuation window in such a way that the actuator can deform the nozzle tube in the actuation window when actuated. Furthermore, the holding module can be moved into a correct arrangement with respect to the dosing module (in which, for example, unintentional crushing is avoided or a calibration structure is oriented with respect to the actuating window).

The first guidance structures can comprise one or more guidance holes which penetrate the dosing module, the second guidance structures can comprise one or more guide pins, and the third guidance structures can comprise one or more guidance holes, wherein each guide pin of the second guidance structures can be configured to extend through a guidance hole of the first guidance structures into a third guidance hole when the dosing module, the holding module and the actuator module are coupled. The guide pins of the second guidance structures can therefore extend through guidance holes of both the dosing module and the actuator module.

This allows the dosing module and the actuator module to be matched on the same guidance structure, which improves the mechanically defined position. Furthermore, the holding module and the dosing module can first of all be coupled to form a composite structure which can be coupled to the actuator module via the guide pins. Since the dosing module comprises no guide pins, material costs and consumption for the dosing module are lower. This is advantageous, in particular, if the dosing module is a module with a higher exchange rate (e.g. as a disposable item).

The holding module and/or the actuator module can comprise a fastening mechanism configured to fasten the holding module to the actuator module in order to couple the dosing module, the holding module and actuator module to each other. The fastening mechanism allows the mechanically defined position to be maintained and improves the precision when ejecting the liquid. Since the fastening mechanism is part of the holding module and/or the actuator module, it is not necessary for the dosing module to comprise a fastening mechanism. This is advantageous, in particular, if the dosing module is a module with a higher exchange rate (e.g. as a disposable item).

The fastening mechanism can comprise magnets on the holding module and/or the actuator module. Such a fastening mechanism allows for simple, tool-free and fast coupling. Furthermore, the attraction force of magnets can be used in conjunction with self-centering geometries.

The holding module can comprise a calibration structure configured to cause a defined deformation of that elastic portion of the nozzle tube which is exposed in the actuation window when the dosing module, the holding module and the actuator module are coupled to each other and before the actuator is actuated.

The calibration structure can comprise a projection on the holding module, which protrudes into the actuation window in the operating state. The projection is therefore arranged near the nozzle tube, with the result that a deflection of the nozzle tube is reduced. This improves the reproducibility of the deformation of the nozzle tube.

The calibration structure can deform the elastic portion of the nozzle tube on a first side, and the actuator can deform the elastic portion of the nozzle tube on a second side opposite the first side, when the dosing module, the holding module and the actuator module are coupled to each other and before the actuator is actuated. The calibration structure thus allows the nozzle tube to be deformed by crushing between the projection and the actuator, which results in a deformation with improved reproducibility.

The holding module can comprise a handle which is provided on a side lying opposite the dosing module and allows a user to couple the holding module to the dosing module and the actuator module. The handle facilitates the coupling of the holding module to the dosing module and/or actuator module for the user.

Examples provide a method for dispensing a droplet from a dosing system as described herein. The method includes providing the dosing module, the holding module and the actuator module; coupling the dosing module to the actuator module and the holding module, wherein the portion of the dosing module is arranged between the actuator module and the holding module; actuating the actuator module, in order to eject one or more droplets from the outlet opening of the nozzle tube; and disconnecting the dosing module at least from the actuator module.

The dosing module, the holding module and the actuator module can be provided as separate components from each other, and the method can further include forming a composite structure comprising the dosing module and the holding module by inserting the portion of the dosing module into a receiving portion of the holding module, wherein coupling of the dosing module to the actuator module and the holding module includes coupling of the composite structure to the actuator module. The provision of three separate components allows the dosing module to be coupled to the holding module as an intermediate step. This can simplify the coupling to the actuator module. Furthermore, various holding modules can thereby be provided in order to improve compatibility with different types of dosing modules.

The method can further include, after disconnecting the composite structure from the actuator module, replacing the dosing module in the composite structure with a new dosing module, coupling the composite structure comprising the new dosing module to the actuator module by detachably coupling the holding module to the actuator module, wherein the portion of the new dosing module is arranged between the actuator module and the holding module, actuating the actuator module to eject one or more droplets from the outlet opening of the nozzle tube of the new dosing module, and disconnecting the composite structure from the actuator module. The handling for both insertion and removal of the nozzle tube can be done via the bracket of the dosing module. Therefore, the operation of the dosing module is simplified. The composite structure of the dosing module and the holding module also allows easy decoupling from the actuator module.

The holding module and the actuator module can be provided as a coupled unit, and the dosing module is provided as a separate component from the coupled unit, wherein the coupling of the dosing module to the actuator module and the holding module includes coupling the dosing module to the coupled unit. The coupled unit can facilitate coupling of the dosing module to the coupled unit (e.g. because the holding module and the actuator module no longer have to be moved or a movement can be of guided configuration with respect to each other).

Examples thus provide dosing modules, dosing systems, and methods for dispensing a droplet. It has been recognized that a nozzle tube fixed to two portions of an actuation window facilitates coupling of the dosing module to other modules, and that the orientation of the nozzle tube can be mechanically defined by the bracket, and thus the precision of droplet dispensing can be improved and the risk of damage to the nozzle tube can be decreased.

### BRIEF DESCRIPTION OF THE DRAWINGS

Embodiments of the invention will be explained in more detail in the following with reference to the accompanying drawings, in which:

FIG. 1 shows a perspective view of one example of a dosing module with a bracket and a nozzle tube;

FIG. 2A shows a perspective top view of the dosing module;

FIG. 2B shows a perspective top view of another example of the dosing module;

FIG. 2C shows a perspective top view of another example of the dosing module;

FIG. 2D shows a perspective top view of another example of the dosing module;

FIG. 3A shows a perspective view of another example of the dosing module with guidance holes;

FIG. 3B shows a perspective view of another example of the dosing module with guidance holes and guide pins;

FIG. 4A shows a perspective view of another example of the dosing module with a funnel-shaped fluid inlet opening;

FIG. 4B shows a perspective view of another example of the dosing module with a funnel-shaped fluid inlet opening;

FIG. 5 shows a perspective view of another example of the dosing module;

FIG. 6A shows a perspective view of a further dosing module, the bracket of which includes a first housing part and a second housing part;

FIG. 6B shows a cross section of the dosing module of FIG. 6A through a dividing plane between the first and second housing part;

FIG. 6C shows a further perspective view of the dosing module of FIG. 6A;

FIG. 7A shows a schematic view of a dosing system including a dosing module, a holding module and an actuator module;

FIG. 7B shows another example of the dosing system with three separate modules;

FIG. 7C shows the three modules of FIG. 7B in engagement;

FIG. 8 shows a perspective view of one example of a holding module;

FIG. 9A shows a perspective front view of a rear wall of the holding module from FIG. 8;

FIG. 9B shows a perspective side view of the holding module from FIG. 8;

FIG. 9C shows a perspective view of the holding module from FIG. 8;

FIG. 10A shows a schematic cross section of one example of an actuator module;

FIG. 10B shows a schematic cross-sectional illustration of a dosing system including the dosing module of FIG. 5, the holding module of FIG. 8 and the actuator module of FIG. 10A; and

FIG. 11 shows a flow chart for a method for dispensing a droplet from a dosing system.

### DETAILED DESCRIPTION OF THE INVENTION

Examples of the present disclosure are described in detail below, using the accompanying drawings. It should be noted that identical elements or elements comprising the same functionality are provided with identical or similar designations, wherein a repeated description of elements with the same or similar designations is typically omitted. In particular, identical or similar elements can each be provided with designations comprising an identical number with a different or no lower case letter. Descriptions of elements that comprise identical or similar designations can be interchangeable. The following description describes many details to provide a more thorough explanation of examples of the disclosure. However, it is obvious to a person skilled in the art that other examples can be implemented without these specific details. Features of the various examples described can be combined with each other, unless features of a corresponding combination are mutually exclusive or such a combination is expressly excluded.

Definitions of some terms used herein are given before examples of the present disclosure are further explained.

The term liquid as used herein also, in particular, includes, as is evident to experts, liquids containing solids, such as suspensions, biological samples and reagents.

The term nozzle tube, as used herein, includes, in particular, elongate hollow bodies (such as a hose) with at least one outlet opening into free space.

Examples of the invention can be used, in particular, in the field of microfluidics, in which the processing of liquids in the picoliter to milliliter range is concerned. Accordingly, the fluidics structures can comprise suitable dimensions in the micrometer range for handling corresponding liquid volumes.

If the expression radial is used herein with respect to the nozzle tube, then radial means perpendicular with respect to a central axis parallel to an extent direction of the nozzle tube. In the case of a nozzle tube with a circular cross section, the radial direction extends perpendicularly with respect to the outer surface of the nozzle tube.

Unless otherwise specified herein, room temperature (20° C.) is to be assumed in each case with regard to temperature-dependent variables.

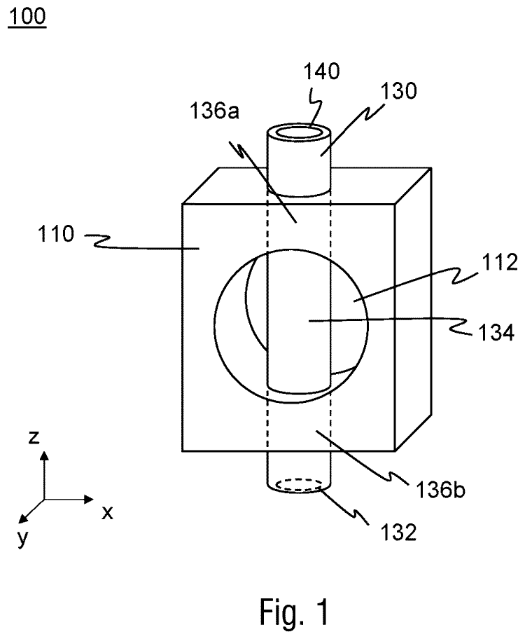

FIG. 1 shows a perspective view of one example of a dosing module 100 with a bracket 110 and a nozzle tube 130. The nozzle tube 130 is fastened to the bracket 110 and comprises an outlet opening 132 (indicated using a dashed line in FIG. 1). The bracket 110 comprises an actuation window 112 which penetrates the bracket 110 and in which a radially (in the x and y direction in FIG. 1) elastic portion 134 of the nozzle tube 130 is exposed, wherein portions 136a, b of the nozzle tube 130 spaced apart from each other in the longitudinal direction (in the z direction in FIG. 1) of the nozzle tube 130 are fixed by portions of the bracket arranged on opposite sides of the actuation window 112 (e.g. to fix the nozzle tube 130 against a movement with respect to the fixing portions of the bracket 110).

It has been recognized that, due to the fixing of the nozzle tube 130 to two portions of the bracket 110, the nozzle tube 130 can be oriented by means of the bracket. Therefore, the nozzle tube 130 can be more easily arranged correctly by a user (e.g. with respect to an actuator and/or a holding module). Therefore, the risk of damage, loss or contamination is reduced. Reducing damage also allows more frequent reuse of the dosing module 100. Furthermore, operation is more time-efficient. Since the nozzle tube 130 does not need to be clamped directly into a holding module, problems that depend on dimensions of the nozzle tube and a holding module (e.g. too loose or too tight frictionally locking connection between the nozzle tube and the holding module) are reduced.

The actuation window 112 of the dosing module 100 not only allows for improved orientation with respect to a holding module and/or actuator module, it can also improve fastening and/or orientation in a packaging. This can reduce transport damage and packaging costs.

The dosing module 100 includes a fluid inlet opening 140 which is fluidically coupled to the outlet opening 132. In the example of FIG. 1, an end (lying opposite the outlet opening 132) of the nozzle tube 130 forms the fluid inlet opening 140. However, the fluid inlet opening 140 can (at least partially) be a part of another component (such as the bracket 110).

In FIG. 1, the fluid inlet opening 140 and the outlet opening 132 are shown protruding from the bracket 110. Alternatively, at least one of the fluid inlet opening 140 and the outlet opening 132 can be provided flush or recessed with respect to a surrounding surface of the bracket 110.

In FIG. 1, the nozzle tube 130 is shown cylindrically at the end with the outlet opening 132. Alternatively, the nozzle tube 130 can comprise a taper, for example in the form of a cone, wherein the outlet opening 132 is formed at an opening by the tip of the cone. The nozzle tube 130 (e.g. the outlet opening 132) can be configured to dispense droplets in the femtoliter to milliliter range (e.g. in the nanoliter to picoliter range).

The bracket 110 includes a frame that frames the actuation window 112. The frame in FIG. 1 has a rectangular shape with a circular actuation window 112. Alternatively, the frame can have a circular, elliptical, or square shape, wherein corners of the frame can optionally be rounded. The actuation window 112 can have a circular, elliptical or square shape. The nozzle tube 130 can extend centrally through the actuation window 112 (e.g. along a symmetry axis of the actuating window) or laterally offset therefrom.

The bracket 110 can include one, two, or more housing parts (for example, housing parts that are immovable with respect to each other). The bracket 110 can include, for example, a single housing which is formed, for example, by means of injection molding around the nozzle tube 130. In another example, the bracket 110 can include two housing parts, each comprising a groove, wherein the grooves form a cylindrical opening for the nozzle tube 130 when the two housing parts are connected to each other (for example, by means of at least one of an adhesive connection, a fusion connection and a snap connection). The grooves can be formed by a spacer for the nozzle tube 130 or by the nozzle tube 130 itself.

The bracket 110 can include or be formed from at least one of (hard) plastic, metal and glass. The bracket 110 (or at least one part, such as one or more housing parts thereof) can be manufactured by means of milling, additive manufacturing (e.g. 3D printing) or an injection molding process. The manufacture of the bracket 110 may include a joining method. The joining method may include at least one of assembling of connection structures, adhesive bonding, welding and forming.

The nozzle tube 130 can include or be an elastic hose. The hose can include a cylindrical shape with a round or oval cross section. The hose can contain an elastic material. The hose can contain at least one of silicone, polytetrafluoroethylene, polyurethane, polyimide, polypropylene, rubber, and polyvinyl chloride. The hose can comprise an outer diameter of less than 10 mm, e.g. less than 5 mm, e.g. less than 2 mm. The hose can comprise an inner diameter of less than 4 mm, e.g. less than 1.5 mm, e.g. less than 0.5 mm (e.g. between 0.1and 0.5 mm).

The nozzle tube 130 includes an elastic material at least in the elastic portion 134. The nozzle tube 130 is configured to deform under the influence of a force in such a way that an inner volume of the nozzle tube 130 is reduced. Consequently, by an action of force (for example by an actuator) a reduction of the inner volume can be caused, whereby a part of a fluid, which can be received in the nozzle tube 130, is pushed to the outlet opening 132.

The nozzle tube can comprise a smaller dimension than the bracket 110 in the direction in which the actuation window 112 penetrates the bracket 110 (in the y direction in FIG. 1), with the result that the nozzle tube 130 is recessed with respect to at least one surface of the bracket 110, in which the actuation window 112 is formed. The bracket 110 protects the nozzle tube 130 from unintentional deformation (e.g. during assembly or actuator actuation). The dosing accuracy of the dosing module 100 is thus increased.

The bracket 110 can further include a fluid inlet opening which is fluidically coupled to the nozzle tube 130. As part of the bracket 110, the fluid inlet opening can protect the elastic nozzle tube 130 from mechanical influences. For example, the risk of damage to the nozzle tube 130 when coupled to a fluid reservoir (e.g. due to tension, compression or torsion) is reduced. Furthermore, the fluid inlet opening can include or form an adapter for a fluid reservoir. The fluid inlet opening may be compatible with the Luer system (e.g. include a female or male Luer lock connector).

The fluid inlet opening can comprise a larger flow cross section than the nozzle tube 130. The larger flow cross section allows for easier coupling to a fluid reservoir and can comprise the dimensions of a standard inlet opening (e.g. of the Luer system). Furthermore, the nozzle tube 130 can be selected independently of the fluid reservoir.

A flow direction perpendicular to the flow cross section of the fluid inlet opening can be arranged at an angle (e.g. greater than zero, e.g. not parallel) with respect to the longitudinal direction of the nozzle tube 130. The fluid inlet opening can therefore be connected to a fluid reservoir that is provided on the side of the dosing module 100 (e.g. on a holding module or an actuator module). The dosing module 100 therefore does not have to be able to support the weight of the fluid reservoir and can therefore be of more compact shape.

The bracket 110 can comprise a plate-shaped first portion, in which the nozzle tube and the actuation window 112 are arranged, and a second portion, in which the fluid inlet opening is arranged. The second portion can protrude radially from the first portion relative to the nozzle tube. The separation into two portions which fulfill two different functions (providing the actuation window and providing the fluid inlet opening) allows independent dimensioning of the two portions. The first portion can thus be of flat and compact dimensions, and the second portion can be dimensioned according to the dimensions of the fluid inlet opening.

The dosing module 100 can comprise first guidance structures for engagement with matching second guidance structures of a holding module and/or third guidance structures of an actuator module. The guidance structures make it easier for the user to arrange the modules correctly with respect to each other. Since the bracket 110 of the dosing module 100 comprises the actuation window 112, the elastic portion of the dosing nozzle 130 received therein is also arranged correctly with respect to the holding module and/or actuator module as a result.

In the example shown in FIG. 1, the nozzle tube 130, in which the actuation window 112 penetrates the bracket 110 (in the y direction in FIG. 1), comprises a smaller dimension than the bracket 110, with the result that the nozzle tube 130 is recessed with respect to at least one surface of the bracket 110, in which the actuation window 112 is formed.

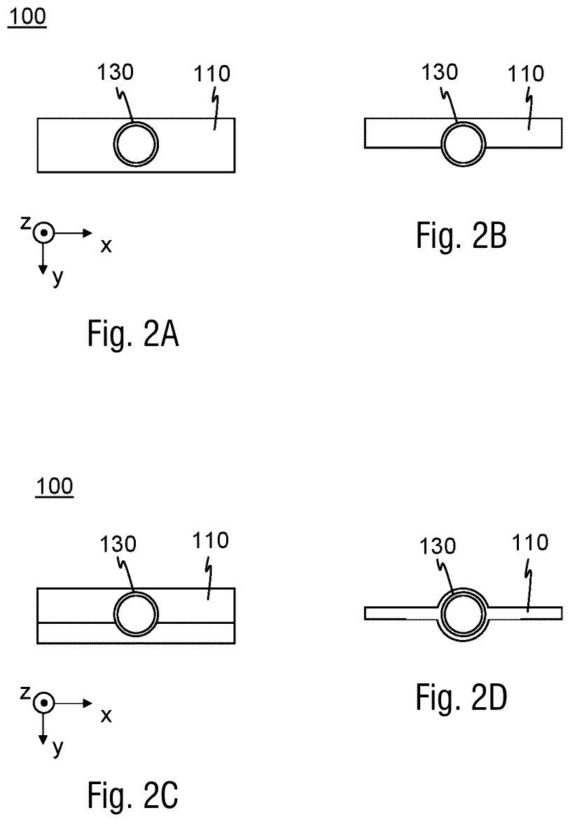

FIG. 2A shows a perspective top view of the dosing module 100. As can be seen therein, the nozzle tube 130 comprises a smaller dimension (e.g. diameter) in the y direction than the bracket 110 (e.g. wall thickness). Such a dimension reduces the risk of unwanted crushing of the nozzle tube 130 and improves the fixing of the nozzle tube in the bracket 110.

FIG. 2B shows a perspective top view of another example of the dosing module 100. The example of FIG. 2B differs substantially from the example of FIG. 2A in that the nozzle tube 130 comprises a larger dimension in the y direction than the bracket 110. Such a dimension increases the compactness of the dosing module 110 and optionally allows the nozzle tube 130 to be deformed by an actuator beyond the actuation window 112.

FIG. 2C shows a perspective top view of another example of the dosing module 100. The example of FIG. 2C differs substantially from the example of 2A in that the bracket 110 comprises different dimensions (e.g. wall thicknesses and/or wall heights) on the two portions for fixing the nozzle tube 130. Thus, in FIG. 2C, the portion comprises a smaller dimension in the positive z direction than in the negative z direction. Therefore, the bracket 110 comprises a step.

In the example of FIG. 2B, the bracket 110 comprises a dimension which comprises a wall thickness between the dimension and half the dimension of the nozzle tube 130. As a result, the bracket 110 engages around the nozzle tube 130 by more than 180°, which improves the fastening of the nozzle tube 130.

FIG. 2D shows a perspective top view of another example of the dosing module 100. The bracket 110 in FIG. 2D has a thin portion and a ring portion which at least partially engages around the nozzle tube 130. The thin portion does not engage around the nozzle tube 130 and can therefore comprise a wall thickness less than half the dimension of the nozzle tube 130.

However, the fixing of the nozzle tube 130 to the bracket 110 does not require the nozzle tube 130 to be engaged around by the bracket 110. Alternatively or additionally, the bracket 110 can include another fastening element for fixing the nozzle tube 130 to the bracket 110. The fastening element can include at least one of an adhesive, a bonding connection, a fusion connection (e.g., of a material of the bracket 110 and a material of the nozzle tube 130), a connection from a shaping method, a connection from an injection molding method (e.g., fixing of the nozzle tube 130 to the bracket 110 by means of injection molding; for example, the bracket 110 or at least a portion thereof can be molded around the nozzle tube 130 by injection molding), a weld, a hook, and an eyelet. The fixing of the nozzle tube 130 to the bracket 110 can be releasable (e.g. a releasable clamping connection between the nozzle tube 130 and the bracket 110) or non-releasable (e.g. a fusion connection or solid adhesive bond between the nozzle tube 130 and the bracket 110).

The dosing module 100 in FIG. 1 shows an actuation window 112 with a circular opening. However, the actuation window 112 can comprise other shapes. The actuation window 112 can comprise an opening with an oval, (e.g. elongate) rectangular, square, (e.g. regular) polygonal shape. The opening can comprise a shape with sharp or round corners.

The dosing module 100 in FIG. 1 shows an actuation window 112 with an opening comprising parallel generatrices (in the y direction). Alternatively, the opening can be of tapered (e.g. conical) configuration. As a result, the opening has a self-centering effect (e.g. for a piston of an actuator).

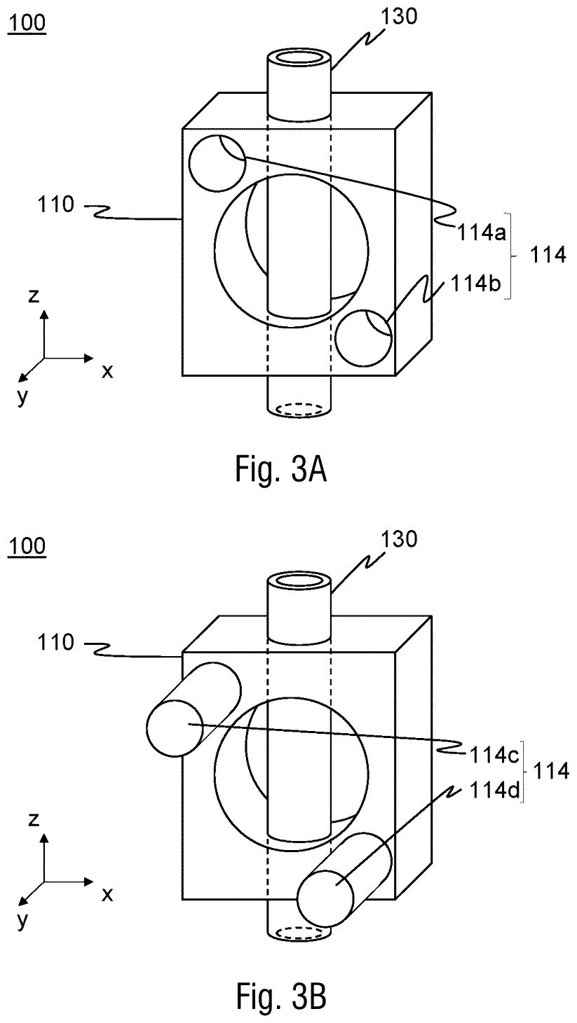

FIG. 3A shows a perspective view of another example of the dosing module 100. The dosing module in FIG. 3A differs from the dosing module in FIG. 1 substantially in that the dosing module 100 or its bracket 110 comprises first guidance structures 114 for engagement with matching second guidance structures (not shown in FIG. 3A) of a holding module and/or third guidance structures of an actuator module. The guidance structures 114 allow correct positioning and/or orientation of the actuation window 112 and thus also correct positioning and/or orientation of the nozzle tube 130 (for example relative to an actuator for deforming the nozzle tube 130 in the actuation window 112).

As shown in FIG. 3A, the guidance structures 114 can include one or more guidance holes 114a, b (e.g. with a rectilinear and/or parallel extent direction). The guidance holes 114a, b can comprise the same shapes and/or dimensions. Alternatively, the guidance holes 114a, b can comprise different shapes (e.g. square, rectangular, oval or round) and/or different dimensions. This can make it easier for a user to find a correct orientation of the dosing module 100.

Alternatively or additionally, the guidance structures 114 can comprise one or more guide pins (e.g. with a rectilinear and/or parallel extent direction). The guidance structure 114 can comprise a guide pin with a cylindrical shape (for example, having a cross section with a round, oval, rectangular, square or polygonal shape). In the case of multiple guide pins, all guide pins can comprise the same shape and/or dimensions or different shapes and/or dimensions.

FIG. 3B shows a perspective view of another example of the dosing module 100. The example of FIG. 3B differs from the example of FIG. 3A substantially by way of guidance structures 114 which comprise guide pins 114c, d (instead of the guidance holes 114a, b).

Alternatively or additionally, the guidance structures may comprise one or more rails, e.g. on lateral sides of the bracket 110.

The guidance structures 114 can be combined as desired. Thus, the guidance structures 114 can comprise, for example, guidance holes 114a, b and guide pins 114c, d or rails. The guidance structures 114 can have generatrices and/or outer surfaces running in parallel. For example, the guidance holes 114a, b and the guide pins 114c, d have parallel generatrices in FIGS. 3A, B. Alternatively, the guidance structures 114 can comprise at least one of a taper, a widened portion, and a local protuberance. Such structures allow a frictionally locking connection when engaged (e.g. by the holding module and/or actuator module).

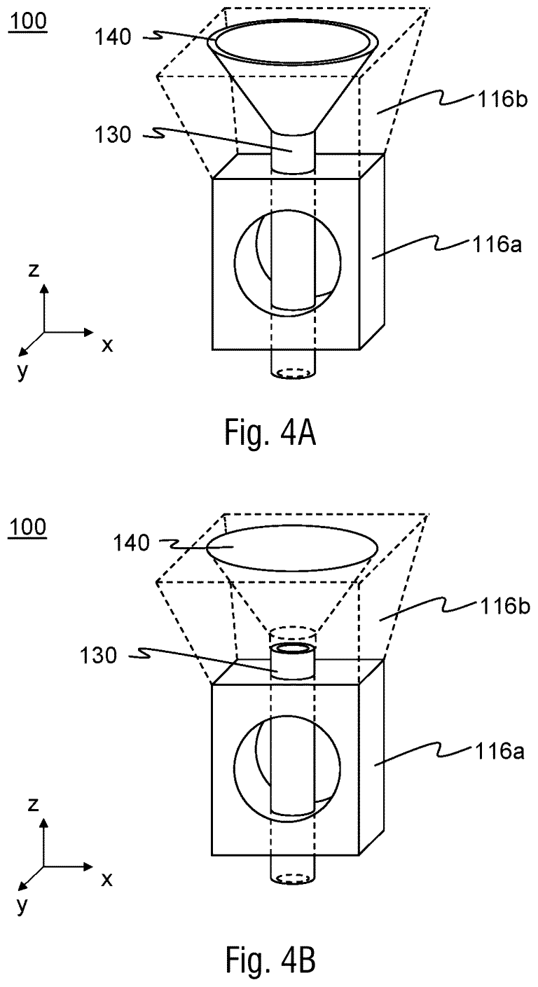

FIG. 4A shows a perspective view of another example of the dosing module 100 with a funnel-shaped fluid inlet opening 140. In the example of FIG. 4A, the fluid inlet opening 140 is a part of the nozzle tube 130. The cross section of the fluid inlet opening 140 can increase in the direction of the opening (in FIG. 4A in the positive z direction) constantly (e.g. no curvature), increase progressively (e.g. positive curvature) or increase in a diminishing manner (e.g. negative curvature).

The funnel-shaped fluid inlet opening 140 comprises a larger cross section in comparison to the part of the nozzle tube 140 coupled to it. This makes it easier to couple the nozzle tube to a fluid reservoir. In addition, the fluid inlet opening 140 can comprise dimensions compatible with common fluid connection pieces (e.g. for laboratory applications, e.g. Luer system connections).

The fluid inlet opening 140 can be used as a fluid reservoir. Thus, the liquid to be ejected can be introduced into the (e.g. funnel-shaped) fluid inlet opening 140 (e.g. by means of a pipette). The introduced liquid can be held in the fluid inlet opening 140 due to at least one of gravity (e.g. in the case of an upwardly opened fluid inlet opening 140), surface tension and interfacial tension. The liquid can then be ejected from the outlet opening 132 of the nozzle tube 130 (e.g. by means of a deformation by an actuator).

The fluid inlet opening 140 can be supported by the bracket 110. The bracket 110 can include a first portion 116a and a second portion 116b. The second portion 116b can support the fluid inlet opening. In FIG. 4A, the bracket 110 comprises a plate-shaped first portion 116a. The second portion 116b of the bracket is indicated in dashed lines.

FIG. 4B shows a perspective view of another example of the dosing module 100, wherein the bracket 110 includes the fluid inlet opening 140. The fluid inlet opening 140 is fluidically coupled to the nozzle tube 130. For this purpose, the nozzle tube 130 can extend into a cavity which is fluidically coupled to the fluid inlet opening 140. The dosing module 100 can include a sealant (e.g. an adhesive) between the cavity and/or the fluid inlet opening 140 firstly and the nozzle tube 130 secondly. However, a seal can also be realized by a contact of the nozzle tube 130 with the cavity and/or the fluid inlet opening 140.

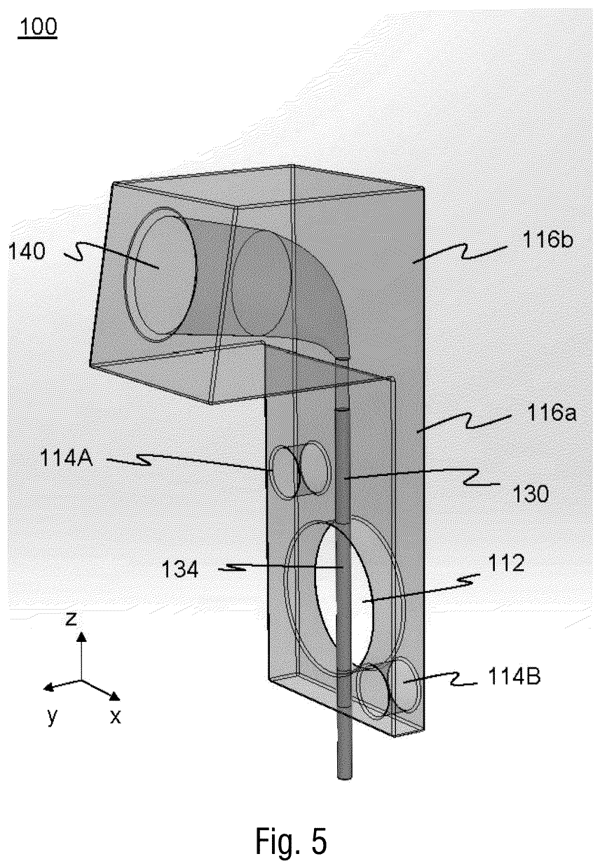

FIG. 5 shows a perspective view of another example of the dosing module 100. The dosing module 100 in FIG. 5 comprises several features from FIGS. 3A and 4B. The dosing module 100 includes guidance structures 114 in the form of guidance holes 114a, b. Furthermore, the bracket 110 includes a first portion 116a and a second portion 116b.

The first portion 116b includes a plate-shaped body with the actuation window 112 and the nozzle tube 130. However, the second portion may also include at least a part of the nozzle tube 130. The second portion includes the fluid inlet opening 140. The fluid inlet opening 140 in FIG. 5 comprises a larger flow cross section than the nozzle tube 130. The fluid inlet opening 140 in FIG. 5 has a funnel shape in one embodiment. Furthermore, the funnel shape has a central axis which comprises a curved extent course. As a result, a flow direction which is oriented perpendicularly with respect to the flow cross section of the fluid inlet opening 140 is arranged at an angle (i.e. at an angle greater than zero) with respect to a longitudinal direction of the nozzle tube 130 (in FIG. 5 in the z direction). In the example in FIG. 5, the flow angle is arranged at an angle of about 80° with respect to the longitudinal direction of the nozzle tube 130. Alternatively, the angle can lie in a range between 5° (or 10° or 20°) and 175° (or 170° or 160°). For example, the angle can be at least substantially 10°, 30°, 45°, 60°, 90°, 120°, or 135°.

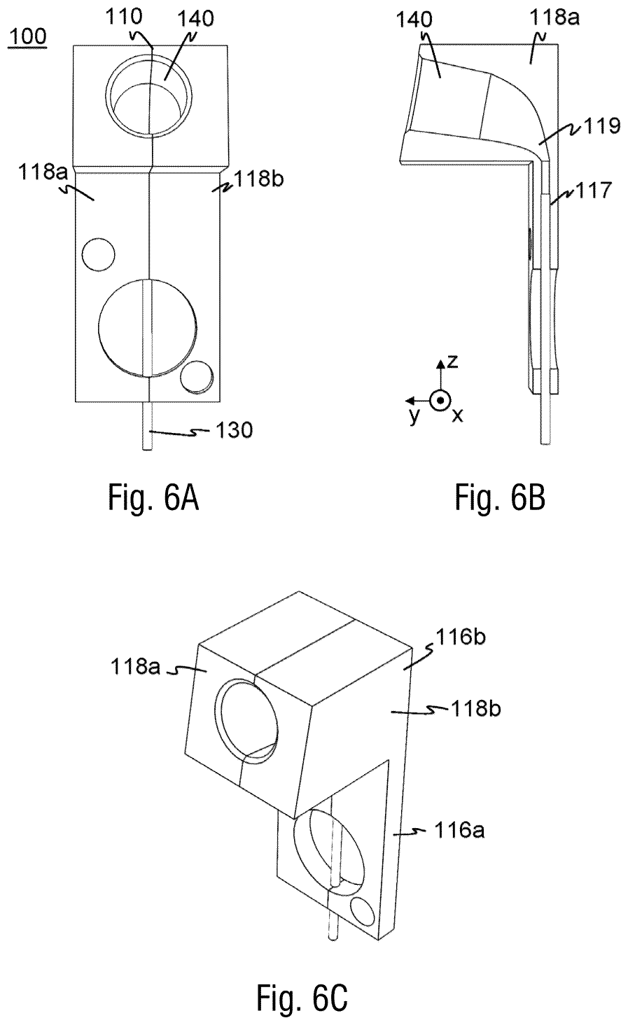

FIG. 6A shows a perspective view of a further dosing module 100, the bracket 110 of which includes a first housing part 118a and a second housing part 118b.

FIG. 6B shows a cross section of the dosing module 100 of FIG. 6A through an imaginary dividing plane between the first and second housing part 118a, b. The dividing line also passes through the nozzle tube 130, with the result that the first and second housing 118a, b each comprises a groove 117, wherein the two grooves 117 together form a cavity which is formed to receive the nozzle tube 130. The two housings 118a, b further each comprise a depression 119, wherein the two depressions 119 together (at least partially) form the fluid inlet opening 140 and a transition between the fluid inlet opening 140 and the nozzle tube 130. The transition can comprise at least substantially the same diameter as the inner diameter of the nozzle tube 130. This creates a smooth transition between the nozzle tube 130 and the fluid inlet opening 140 with improved flow properties and reduced air pockets. Such a transition is not limited to the dosing module 100 with two housing parts 118a, b and can also be realized in combination with all dosing modules 100 described herein.

FIG. 6C shows a further perspective view of the dosing module of FIG. 6A.

FIGS. 6A-C show a dosing module with two housing parts 118a, b. Alternatively, the bracket 110 can also include three, four, five, or more housing parts. For example, the first and second portions 116a, b can each include different housing parts. Furthermore, the first portion 116 can include more than two (e.g. three or four) housings, for example to allow a modular structure for different guidance structures.

The housing parts 118a, b are shown in FIGS. 6A-C with flat connection surfaces. However, the housing parts 118a, b can also comprise connection structures (e.g. connecting pins and/or connecting openings).

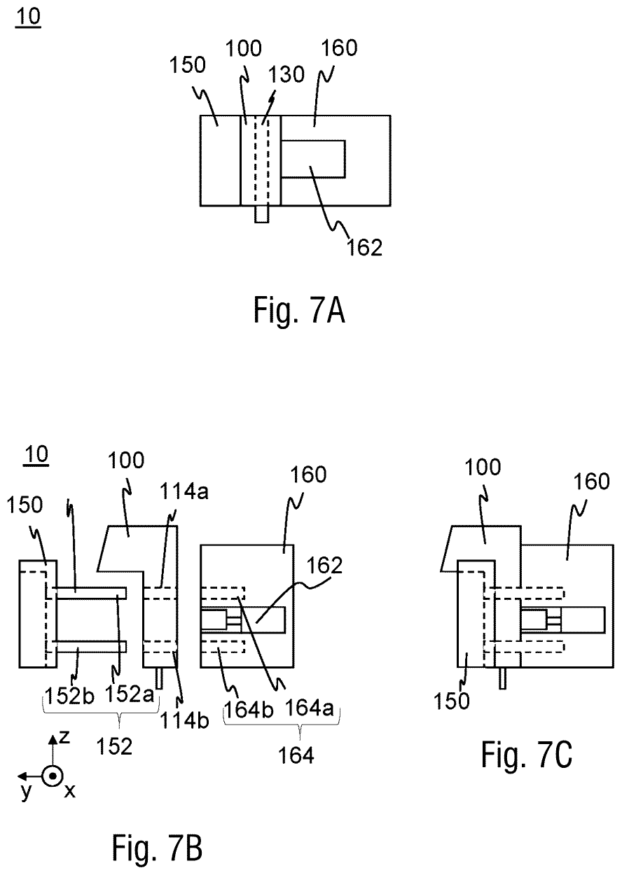

FIG. 7A shows a schematic view of a dosing system 10 including a dosing module 100 as described herein, a holding module 150 (for example, a holding module 150 provided separately from the dosing module 100) and an actuator module 160 (for example, an actuator module 160 provided separately from the dosing module 100). The holding module is configured to hold the dosing module 100 on a first side. The actuator module 160 is configured to hold the dosing module 100 on a side opposite the first side, and comprises an actuator 162 configured to cause a deformation of the nozzle tube 130 to release droplets at an outlet opening 132 of the nozzle tube 130. The dosing module 130, and at least one of the holding module 150 and the actuator module 160 are separate modules configured to be coupled in an operating state to each other and to be disconnected from each other again.

The dosing module 100, the holding module 150 and the actuator module 160 can be provided, for example, as three modules which can be disconnected from each other. Alternatively, the holding module 150 and the actuator module 160 can be a combined module that can be disconnected from the dosing module 100. In this case, for example, the holding module 150 can be formed displaceably with respect to the actuator module 160, wherein the dosing module can be inserted into a gap between the holding module 150 and the actuator module 160. The holding module 150 can be provided separately from the dosing module 100 (in particular separately from the bracket 110).

The actuation window 112 can be formed in a plate-shaped portion 116a of the dosing module 100, wherein the holding module 112 comprises a receiving portion configured to receive the plate-shaped portion 116a at least partially in the operating state. The receiving portion can make it easier for the user to orient the dosing module 100.

The bracket 100 can comprise a portion protruding from the plate-shaped portion 116a, in which the fluid inlet opening 140 is arranged and which protrudes radially with respect to the nozzle tube 130 from the first portion, wherein, in the operating state, the protruding portion protrudes beyond an edge of the holding module 150, which is arranged in the longitudinal direction on the side of the holding module facing away from the nozzle opening. Due to the protrusion of the portion, the holding module 150 can be arranged closer to the dosing module 100, with the result that a compact arrangement of the modules can be realized. Furthermore, a distance between the fluid inlet opening 140 and a fluid reservoir of the (or in the vicinity of the) dosing module 100 can be reduced.

The dosing module 100 can comprise first guidance structures 114a, b and the holding module 150 can comprise matching second guidance structures configured to engage with the first guidance structures 114a, b and to move the holding module 150 and the dosing module 100 in a mechanically defined position with respect to each other. The guidance structures facilitate correct arranging of the holding module 150 with respect to the dosing module 100 and the exposed elastic portion 134 of the nozzle tube 130 received therein.

The actuator module 160 can comprise third guidance structures configured to interact with the first and/or second guidance structures to move the actuator module 160, the dosing module 100 and the holding module 150 into a mechanically defined position with respect to each other. The third guidance structures make it easier for the user to correctly orient the actuator module 160 (and its actuator 162) and the dosing module 100 (and the exposed elastic portion 134 of the nozzle tube 130 received therein) with respect to each other.

The first guidance structures can comprise one or more guidance holes 114a, b which penetrate the dosing module 100, the second guidance structures can comprise one or more guide pins and the third guidance structures can comprise one or more guidance holes, wherein each guide pin of the second guidance structures is configured to extend through a guidance hole 114a, b of the first guidance structures into a third guidance hole when the dosing module, the holding module and the actuator module are coupled. Since both the dosing module 100 and the actuator module 160 comprise guidance holes, all three modules can be correctly oriented with respect to each other at the same time by means of the guide pins of the holding module.

The holding module 150 and/or the actuator module 160 can comprise a fastening mechanism configured to fasten the holding module 150 to the actuator module 160 in order to couple the dosing module 100, the holding module 150 and actuator module 160 to each other. The fastening mechanism allows all three modules to be fixed together. This can reduce the number of fastening mechanisms required.

The fastening mechanism can comprise one or more magnets on the holding module 150 and/or actuator module 160. Such a fastening mechanism can be implemented with low complexity and can be operated in a time-efficient manner. A risk of unintentional crushing of the nozzle tube 130 when the magnetic fastening mechanism engages is reduced due to the actuation window 112. Alternatively or additionally, the fastening mechanism can include one or more snap connections (e.g. snap hooks or ring snap connections).

The holding module 150 can comprise a calibration structure configured to cause a defined deformation of the elastic portion 134 of the nozzle tube 130 exposed in the actuation window 112 when the dosing module 100, the holding module 150 and the actuator module 160 are coupled to each other and before the actuator 162 is actuated. This improves the reproducibility of the deformation and reduces the gradual stretching of the nozzle tube 130.

The calibration structure can comprise a projection on the holding module 150, which protrudes into the actuation window 112 in the operating state. The projection is therefore arranged near the nozzle tube 130, with the result that a deflection of the nozzle tube 130 is reduced. The calibration structure can be formed in one piece with a rear wall of the holding module.

The calibration structure can deform the elastic portion 134 of the nozzle tube 130 on a first side, and the actuator 162 can deform the elastic portion 134 of the nozzle tube 130 on a second side opposite the first side, when the dosing module 100, the holding module 150 and the actuator module 160 are coupled to each other and before the actuator 162 is actuated. The calibration structure thus enables the nozzle tube 130 to be deformed by means of crushing between the projection and the actuator 162, which realizes a deformation with improved reproducibility.

The holding module 150 can comprise a handle which is provided on a side opposite the dosing module 150 and allows a user to couple the holding module 150 to the dosing module 100 and the actuator module 160. The handle facilitates coupling for the user. In particular, in the case that the holding module 150 comprises guide pins and the dosing module 100 and the actuator module 160 comprise guidance holes, the handle allows the user to guide the guide pins through the guidance holes.

FIG. 7B shows another example of the dosing system 10 with three separate modules 100, 150, 160. The dosing module 100 includes first guidance structures 114 which comprise two guidance holes 114A, B by way of example in FIG. 7B.

FIG. 7C shows the three modules from FIG. 7B in engagement.

The holding module 150 comprises second guidance structures 152 corresponding to the first guidance structures 114, which in FIG. 7B comprise, for example, two guide pins 152a, b configured to engage with the first guidance structures 114 and to move the holding module 150 and the dosing module 100 into a mechanically defined position with respect to each other. In the example of FIG. 7B, the guide pins 152a, b can be guided through the guidance holes 114a, b. Thus, the position of the holding module 150 relative to the dosing module 100 is mechanically defined in a plane perpendicularly with respect to the direction of extent of the guide pins 152a, b (in FIGS. 7B, C the x-z plane). If the guide pins 152a, b are inserted up to a stop (for example, up to contact of the holding module 150 with the dosing module 100 and/or contact of front surfaces of the guide pins 152a, b with a stop of the actuator module 160), the position and orientation of the dosing module 100 (and thus also of the nozzle tube 130) is mechanically defined with respect to the holding module 150.

As shown, for example, in FIG. 7B, the actuator module 160 can comprise third guidance structures 164 configured to interact with the first guidance structures 114 and/or second guidance structures 152 in order to move the actuator module 160, the dosing module 100 and the holding module 150 into a mechanically defined position with respect to each other. The third guidance structures 164 comprise as an example two third guidance holes 164a, b. The third guidance holes 164a, b are configured to receive the guide pins 152a, b of the holding module 150.

The first guidance structures 114 thus comprise one or more guidance holes 114a, b which penetrate the dosing module 100 (such as the first portion thereof), the second guidance structures 152 comprise one or more guide pins 152a, b, and the third guidance structures 162 comprise one or more guidance holes 164a, b, wherein each guide pin 152a, b of the second guidance structures is formed to extend through a guidance hole 114a, b of the first guidance structures into a third guidance hole 164a, b, when the dosing module 100, the holding module 150 and the actuator module 160 are coupled.

The guidance structures of the dosing module 100, the holding module 150 and the actuator module 160 can be configured to fix the coupling. At least one of the guide pins 152a, b can, for example, realize a frictionally locking connection to at least one of the guidance holes 114a, b, 164a, b. For this purpose, at least one of the guidance holes 114a, b, 164a, b and/or of the guide pins 152a, b can comprise a taper or widened portion.

Alternatively or additionally, the holding module 150 and/or the actuator module 160 can comprise a fastening mechanism configured to fasten the holding module 150 to the actuator module 160 in order to couple the dosing module 100, the holding module 150 and actuator module 160 to each other. The fastening mechanism can include at least one of a screw, a magnet, a snap connection, a hook and an eyelet. For example, the fastening mechanism can comprise one or more magnets on the holding module 150 and/or the actuator module. The magnetic coupling can take place between two magnets or a magnet and a ferromagnetic element. In particular, the dosing module 100 can include a ferromagnetic element, and the holding module 150 and/or the actuator module 160 can include one or more magnets. This reduces the manufacturing costs of the dosing module 100, especially when used as a disposable product. A fastening mechanism that comprises a magnet, snap connection or similar connection can be operated without tools and facilitates operation. Furthermore, a fastening mechanism with a magnet or a snap connection does not comprise a degree of fastening (such as a screw with a variable tensile force), with the result that the risk is reduced that the user unintentionally uses too high a degree of fastening which could lead to damage to the nozzle tube 130. A fastening mechanism without magnets (e.g. with a snap connection and/or a screw) has improved compatibility with fluids that are susceptible to magnetic fields (e.g. a liquid with metallic particles, magnetic microbeads).

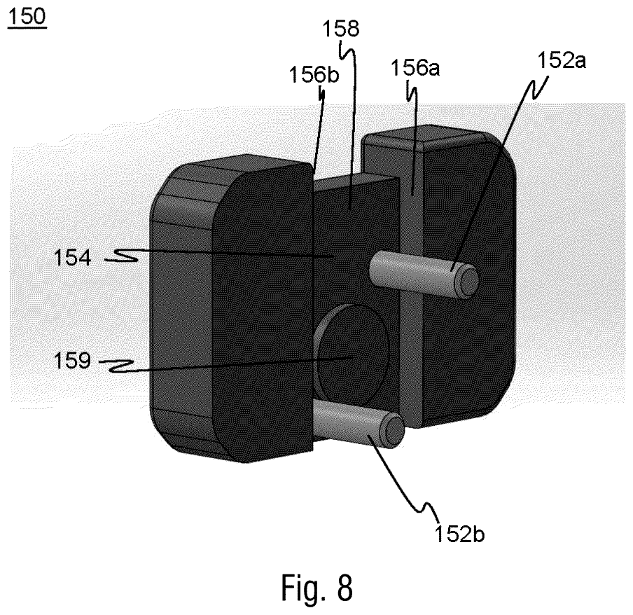

FIG. 8 shows a perspective view of one example of a holding module 150. The holding module 150 can comprise a receiving portion 154 configured to at least partially receive the plate-shaped portion of the dosing module 100 (such as the bracket 100 in FIGS. 1 to 3B or the first portion 116A in FIG. 4A to 7C) in the operating state. The receiving portion 154 can comprise one or more lateral walls. In the example in FIG. 5, the receiving portion 154 has two lateral walls 156a, b which are arranged in the operating state on opposite sides of the plate-shaped portion of the dosing module 100. The lateral walls 156a, b can run in parallel. The receiving portion 154 can comprise a rear wall 158 which is arranged in the operating state on that side of the dosing module 150 facing away from the actuator module 160. The rear wall 158 can be vertically oriented with respect to at least one of the lateral walls 156a, b. The rear wall 158 and the lateral walls 156a, b form a depression configured to receive the plate-shaped portion of the dosing module 100.

The receiving portion 154 can include one or more magnets. The one or the plurality of magnets can be fastened on a surface of the receiving portion 154, can be recessed in the surface or can be provided within the holding module 150. At least one of the lateral walls 156a, b and/or the rear wall 158 can comprise at least one magnet. The dosing module 100 can include a magnet and/or a ferromagnetic material that can interact with the magnet of the receiving portion 154 in such a way that the dosing module 100 is held in the receiving portion 154.

The holding module 150 can further comprise a calibration structure 159 configured to cause a defined deformation of the elastic portion 134 of the nozzle tube 130 exposed in the actuation window 112, when the dosing module 100, the holding module 150 and the actuator module 160 are coupled to each other and before the actuator 162 is actuated.

The calibration structure 159 can comprise a projection on the holding module which protrudes into the actuation window 112 in the operating state. The projection can extend from the rear wall 158. The projection can have a contact surface which is directed in the operating state toward the exposed elastic portion 134 of the nozzle tube 130. The contact surface can be flat, as shown in FIG. 8. Alternatively, the contact surface can comprise a concave or convex curvature. Alternatively or additionally, the contact surface can comprise an elongate recessed portion which is formed to receive a part of the nozzle tube 130.

The projection can comprise a similar or at least substantially similar shape to the actuation window 112. If, for example, the actuation window 112 has a circular shape, the projection can likewise have a circular cross section and can be formed, for example, as a circular cylinder. In particular, when the nozzle tube 130 is recessed with respect to the surface of the bracket 110, the projection can comprise a smaller dimension (e.g. diameter) than the actuation window 112, with the result that the projection can protrude into the actuation window 112.

The calibration structure 159 can be configured to deform the elastic portion 134 of the nozzle tube 130 on a first side. The actuator 162 can be formed to deform the elastic portion 134 of the nozzle tube 130 on a second side opposite the first side when the dosing module 100, the holding module 150 and the actuator module 160 are coupled to each other and before the actuator 162 is actuated. The deformation can reduce the cross section of the elastic portion 134 of the nozzle tube 130 by less than 50%, less than 25%, less than 10%, less than 5% or less than 1% compared to an undeformed cross section.

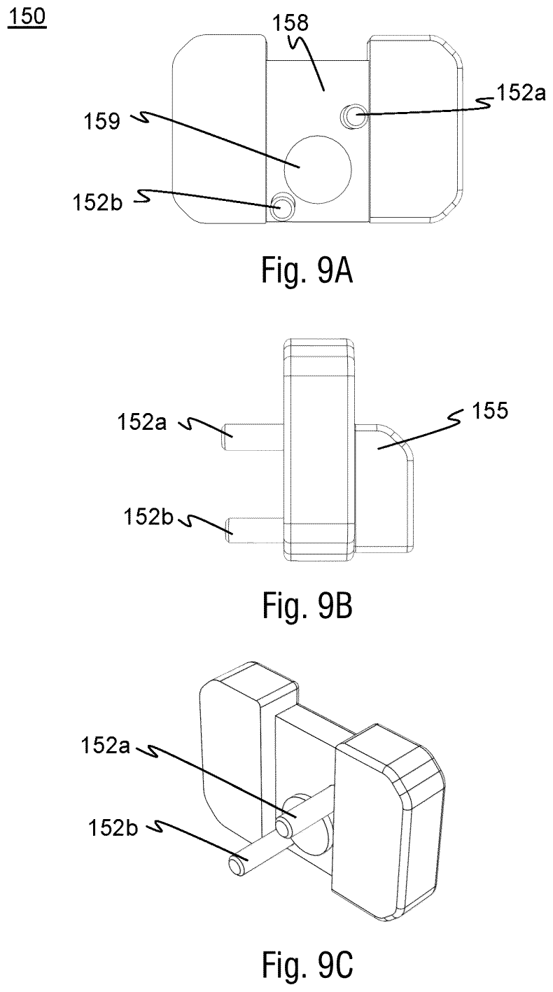

FIG. 9A shows a perspective front view of the rear wall 158 of the holding module 150 from FIG. 8.

FIG. 9B shows a perspective side view of the holding module 150 from FIG. 8. The holding module 150 can comprise a handle 155 which is provided on a side opposite the dosing module 100 and allows a user to couple the holding module 150 to the dosing module 100 and the actuator module 160. The handle 155 can include a plate-shaped attachment configured to be gripped, for example, between thumb and index finger. The handle can include a mechanism (not shown) configured to control the fastening mechanism. The mechanism can include a lever or a rotary knob.

FIG. 9C shows a perspective view of the holding module 150 from FIG. 8.

The holding module 150 can be manufactured according to one of the methods as described herein for the bracket. The holding module 150 or at least components thereof (e.g. guide pins 152a, b and/or the receiving portion 154) can be manufactured, for example, by means of milling, an additive process (e.g. 3D printing) or casting.

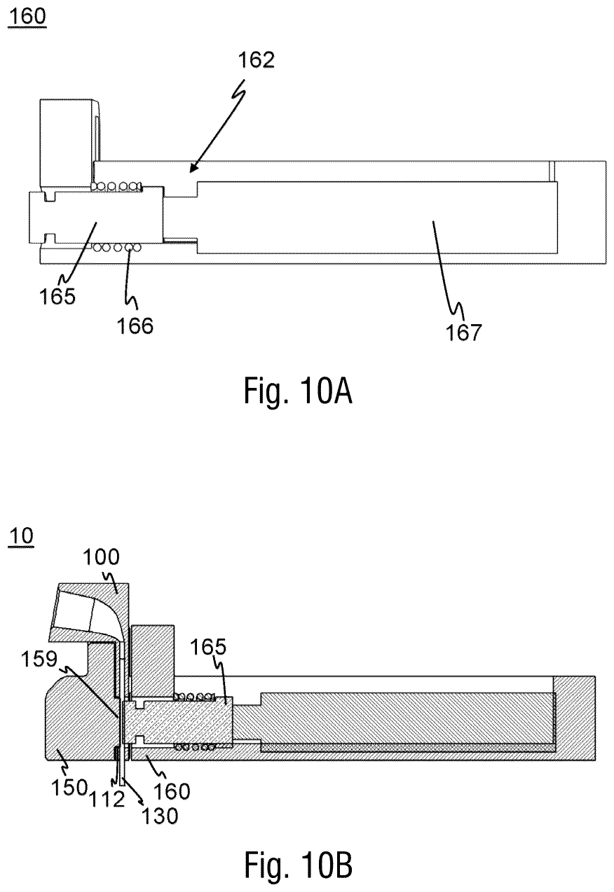

FIG. 10A shows a schematic cross section of one example of an actuator module 160. The actuator module 160 in FIG. 10A includes an actuator 160 with a plunger 165, a resetting means 166 (e.g. a spring) and a linear actuator 167. The linear actuator 167 is configured to deflect the plunger 165 in operation in the direction of the elastic portion 134 of the nozzle tube 130 (and the calibration structure 159 lying behind it). The linear actuator 167 is configured to deflect the plunger 165 counter to a resetting force of the resetting means 166. The resetting means 166 is configured to move the plunger into an undeflected position when the linear actuator 167 causes no deflection. Alternatively, the linear actuator 167 can be configured to move the plunger in both directions (optionally with the aid of the resetting means 166).

The actuator 162 is therefore configured to deform the nozzle tube 130 by means of the plunger. If the nozzle tube 130 is pre-deformed (or pre-stressed) by means of the calibration structure 159, the nozzle tube 130 can be compressed or crushed between the calibration structure 159 and the plunger when the actuator 162 is actuated. Alternatively, the nozzle tube, fixed merely by the actuation window 112 (i.e.: without a pre-deformation by a calibration structure 159), can be deformed by the actuator 162.

FIG. 10B shows a schematic cross-sectional illustration of a dosing system 10 including the dosing module of FIG. 5, the holding module of FIG. 8 and the actuator module of FIG. 10A. The modules are coupled to each other to form an operating state.

In the operating state, the calibration structure 159 extends into the actuation window 112 and bears against the elastic portion 134 of the nozzle tube 130 in such a way that the nozzle tube 130 is pre-deformed. FIG. 10B shows the plunger 165 of the actuator 162 in a deflected state. Consequently, the elastic portion 134 of the nozzle tube 130 is deformed by the nozzle tube 130 being crushed between the calibration structure 159 and the plunger. The resulting volume reduction within the nozzle tube 130 causes dispensing of a fluid received in the nozzle tube 130 (not shown in FIG. 10B). The fluid can be dispensed in the form of individual droplets, in the form of a fluid jet or in the form of a plurality of droplets. The at least one of a number of drops, a dispensed amount of fluid, and a droplet volume can be controlled by the speed and/or degree of deflection of the plungers. The droplets can, for example, comprise a volume in the nanoliter to picoliter range (e.g. between 50 pl and 500 nl) and/or a diameter between 50 μm and 1 mm.

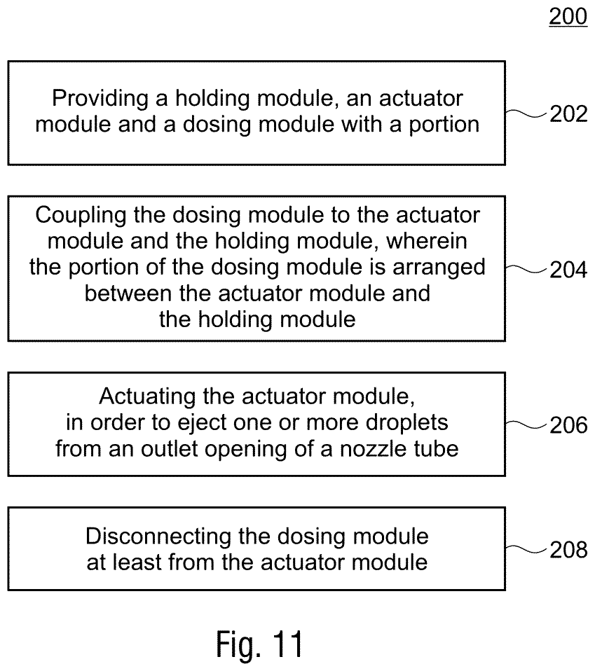

FIG. 11 shows a flow chart 200 for a method for dispensing a droplet from a dosing system 10 as described herein.

The method includes, in step 202, providing the dosing module 100 with the portion 116a, the holding module 150 and the actuator module 160.

The method includes, in step 204, coupling the dosing module 100 to the actuator module 160 and the holding module 150, wherein the portion of the dosing module is arranged between the actuator module and the holding module.

The method includes, in step 206, actuating the actuator module, in order to eject one or more droplets from the outlet opening of the nozzle tube.

The method includes, in step 208, disconnecting the composite structure from the actuator module.

The method allows a dosing module to be mounted and one or more droplets to be ejected from the dosing module. When coupling the composite structure, the risk of the nozzle tube 130 being incorrectly arranged with respect to the holding module 150 and the actuator module 160 is reduced, because the nozzle tube 130 is fixed to two portions of the bracket 110. Therefore, the arrangement of the nozzle tube 130 is guided through the receiving portion 154 when inserting the dosing module 100.

The method can include filling the nozzle tube 130 and/or the fluid inlet opening 140 with the liquid to be ejected. The filling can include introducing droplets by means of a pipette (e.g. into the fluid inlet opening 140) and/or coupling a fluid reservoir to the fluid inlet opening 140.

The dosing module 100, the holding module 150 and the actuator module 160 can be provided as separate components, and the method can further include forming a composite structure comprising the dosing module 100 and the holding module 150 by inserting the portion 116a of the dosing module 100 into a receiving portion 154 of the holding module 150, wherein coupling 204 the dosing module 100 to the actuator module 160 and the holding module 150 includes coupling the composite structure to the actuator module 160. Coupling the composite structure to the actuator module 160 can include releasably coupling the holding module 150 to the actuator module 160.

The method can further include, after disconnecting the composite structure from the actuator module 160, replacing the dosing module 100 in the composite structure with a new dosing module.

The method can include coupling the composite structure comprising the new dosing module to the actuator module 160 by detachably coupling the holding module 150 to the actuator module 160, wherein the portion of the new dosing module is arranged between the actuator module 160 and the holding module 150.

The holding module 150 and the actuator module 160 can be provided as a coupled unit, and the dosing module 150 can be provided as a separate component from the coupled unit, wherein coupling 204 the dosing module 100 to the actuator module 160 and the holding module 150 includes coupling the dosing module 100 to the coupled unit. The holding module 150 in the coupled unit can be rigidly arranged relative to the actuator module 160. In this case, coupling the dosing module 100 can include inserting into an opening (e.g. slot) between the holding module 150 and the actuator module 160. Alternatively, the holding module 150 and the actuator module 160 in the coupled unit can be arranged in a movable manner with respect to each other (e.g. on a rail or by means of a rotary axis). In this case, coupling the dosing module 100 can arranging the dosing module between the holding module 150 and the actuator module 160 and joining the holding module 150 and the actuator module 160.

The method can further include actuating the actuator module 160, in order to eject one or more droplets from the outlet opening of the nozzle tube of the new dosing module.

The method can include disconnecting the composite structure from the actuator module.

The actuation window of the two dosing modules improves the likelihood of the corresponding nozzle tube being oriented identically with respect to the actuator.

Inserting the portion of the dosing module 100 into the receiving portion 154 of the holding module 150 can include engaging the first guidance structures of the dosing module 100 with matching second guidance structures of the holding module and/or third guidance structures of the actuator module. Inserting the portion of the dosing module 100 into the receiving portion 154 of the holding module 150 can comprise inserting one or more guide pins 152a, b into a respective first guidance hole 114a, b and/or second guidance hole 164a, b.

Forming the composite structure can include introducing or inserting the dosing module 100 into the receiving portion 154 of the holding module 150, with the result that the calibration structure 159 is mechanically oriented with respect to the actuation window 112. The dosing module 100 and the holding module 150 form a mechanically defined unit, which can be accommodated in the composite structure by the actuator module 160. When receiving the composite structure in the actuator module 160, the calibration structure 159, the actuation window 112 with the nozzle tube 130, and the actuator 162 (for example, a plunger thereof) can be moved into a mechanically predefined geometric arrangement with respect to each other.

Coupling the composite structure can include actuating the fastening mechanism. Releasing the coupled composite structure can include releasing the fastening mechanism. Coupling the composite structure can include connecting the fluid inlet opening 140 to a fluid reservoir.

Actuating the actuator module 162 may include providing power for a motor of the actuator 162. Actuating the actuator module 162 can include operating a user interface (e.g. an electrical switch, a rotary knob or a touch-sensitive surface). Actuating the actuator module 162 can comprise a repeated movement of an actuator piston to repeatedly eject one or more droplets from the outlet opening 132 (for example, by repeatedly crushing and relaxing the elastic portion 134 of the nozzle tube 130).

Although features of the invention have been described in each case by means of device features or method features, it is obvious to experts that corresponding features can also each be part of a method or device. Thus, the device can be configured in each case to perform corresponding method steps, and the respective functionality of the device can represent corresponding method steps.

In the previous detailed description, different features were in part grouped together in examples to streamline the disclosure. This type of disclosure should not be interpreted as the intention that the claimed examples comprise more features than are explicitly stated in each claim. Rather, as the following claims reflect, the subject matter can lie in less than all the features of a single disclosed example. Consequently, the following claims are hereby incorporated into the detailed description, wherein each claim can be an individual separate example. While each claim can be an individual separate example, it should be noted that, although dependent claims in the claims refer back to a specific combination with one or more other claims, other examples also include a combination of dependent claims with the subject matter of each other dependent claim or a combination of each feature with other dependent or independent claims. Such combinations are included unless it is stated that a specific combination is not intended. It is also intended that a combination of features of one claim with any other independent claim is also included, even if this claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A dosing module for use in a dosing system configured to dispense droplets at an outlet opening of a nozzle tube by deformation of the nozzle tube, the dosing module comprising:
a bracket, and
a nozzle tube which is fastened to the bracket and comprises the outlet opening,
wherein the bracket comprises:
an actuation window which penetrates the bracket and in which a radially elastic portion of the nozzle tube is exposed,
wherein portions of the nozzle tube spaced apart from each other in the longitudinal direction of the nozzle tube are fixed by portions of the bracket arranged on opposite sides of the actuation window.

2. The dosing module as claimed in claim 1, wherein the nozzle tube comprises a smaller dimension than the bracket in the direction in which the actuation window penetrates the bracket, with the result that the nozzle tube is recessed with respect to at least one surface of the bracket, in which the actuation window is formed.

3. The dosing module as claimed in claim 1, wherein the bracket further comprises a fluid inlet opening which is fluidically coupled to the nozzle tube.

4. The dosing module as claimed in claim 3, wherein the fluid inlet opening comprises a larger flow cross section than the nozzle tube.

5. The dosing module as claimed in claim 3, wherein a flow direction perpendicular to the flow cross section of the fluid inlet opening is arranged at an angle with respect to the longitudinal direction of the nozzle tube.

6. The dosing module as claimed in claim 3, wherein the bracket comprises a plate-shaped first portion, in which the nozzle tube and the actuation window are arranged, and a second portion, in which the fluid inlet opening is arranged, wherein the second portion protrudes from the first portion radially with respect to the nozzle tube.

7. The dosing module as claimed in claim 1, comprising first guidance structures for engagement with matching second guidance structures of a holding module and/or third guidance structures of an actuator module.

8. A dosing system comprising:
a dosing module as claimed in claim 1;
a holding module configured to hold the dosing module on a first side; and
an actuator module configured to hold the dosing module on a side opposite the first side, and comprising an actuator configured to cause a deformation of the nozzle tube to dispense droplets at an outlet opening of the nozzle tube,
wherein the dosing module and at least one of the holding module and the actuator module are separate modules configured, in an operating state, to be coupled to each other and to be separated from each other again.

9. The dosing system as claimed in claim 8, wherein the actuation window is formed in a plate-shaped portion of the dosing module, wherein the holding module comprises a receiving portion configured to receive the plate-shaped portion at least partially in the operating state.

10. The dosing system as claimed in claim 9, wherein the receiving portion comprises lateral walls, arranged in the operating state on opposite sides of the plate-shaped portion of the dosing module, and a rear wall, arranged in the operating state on that side of the dosing module facing away from the actuator module.

11. The dosing system as claimed in claim 9, wherein the bracket further comprises a fluid inlet opening which is fluidically coupled to the nozzle tube, and wherein the bracket comprises a portion which protrudes from the plate-shaped portion, in which the fluid inlet opening is arranged, and which protrudes radially with respect to the nozzle tube from the first portion, wherein, in the operating state, the protruding portion protrudes beyond an edge of the holding module, which is arranged in the longitudinal direction on that side of the holding module which faces away from the nozzle opening.

12. The dosing system as claimed in claim 8, wherein the dosing module comprises first guidance structures and the holding module comprises matching second guidance structures configured to engage with the first guidance structures and to move the holding module and the dosing module into a mechanically defined position with respect to each other.

13. The dosing system as claimed in claim 12, wherein the actuator module comprises third guidance structures configured to interact with the first and/or second guidance structures in order to move the actuator module, the dosing module and the holding module into a mechanically defined position with respect to each other.

14. The dosing system as claimed in claim 13, wherein the first guidance structures comprise one or more guidance holes which penetrate the dosing module, the second guidance structures comprise one or more guidance pins, and the third guidance structures comprise one or more guidance holes, wherein each guide pin of the second guidance structures is configured to extend through a guidance hole of the first guidance structures into a third guidance hole when the dosing module, the holding module and the actuator module are coupled.

15. The dosing system as claimed in claim 8, wherein the holding module and/or the actuator module comprise(s) a fastening mechanism configured to fasten the holding module to the actuator module in order to couple the dosing module, the holding module and actuator module to each other.

16. The dosing system as claimed in claim 15, wherein the fastening mechanism comprises magnets on the holding module and the actuator module.

17. The dosing system as claimed in claim 8, wherein the holding module comprises a calibration structure configured to cause a defined deformation of that elastic portion of the nozzle tube which is exposed in the actuation window when the dosing module, the holding module and the actuator module are coupled to each other and before the actuator is actuated.

18. The dosing system as claimed in claim 17, wherein the calibration structure comprises a projection on the holding module, which protrudes into the actuation window in the operating state.

19. The dosing system as claimed in claim 17, wherein the calibration structure deforms the elastic portion of the nozzle tube on a first side, and the actuator deforms the elastic portion of the nozzle tube on a second side opposite the first side, when the dosing module, the holding module and the actuator module are coupled to each other and before the actuator is actuated.

20. The dosing system as claimed in claim 8, wherein the holding module comprises a handle which is provided on a side opposite the dosing module and allows a user to couple the holding module to the dosing module and the actuator module.

21. A method for dispensing a droplet from a dosing system as claimed in claim 8, comprising:
providing the dosing module with a portion, of the holding module and the actuator module;
coupling the dosing module to the actuator module and the holding module, wherein the portion of the dosing module is arranged between the actuator module and the holding module;
actuating the actuator module, in order to eject one or more droplets from the outlet opening of the nozzle tube; and
disconnecting the dosing module at least from the actuator module.

22. The method as claimed in claim 21, wherein the dosing module, the holding module and the actuator module are provided as separate components, and the method further comprises:
forming a composite structure comprising the dosing module and the holding module by inserting the portion of the dosing module into a receiving portion of the holding module, wherein coupling the dosing module to the actuator module and the holding module comprises coupling the composite structure to the actuator module.

23. The method as claimed in claim 22, further comprising:
after disconnecting the composite structure from the actuator module, replacing the dosing module in the composite structure with a new dosing module;
coupling the composite structure comprising the new dosing module to the actuator module by detachably coupling the holding module to the actuator module, wherein the portion of the new dosing module is arranged between the actuator module and the holding module;
actuating the actuator module to eject one or more droplets from the outlet opening of the nozzle tube of the new dosing module; and
disconnecting the composite structure from the actuator module.

24. The method as claimed in claim 21, wherein the holding module and the actuator module are provided as a coupled unit, and the dosing module is provided as a separate component from the coupled unit, wherein coupling the dosing module to the actuator module and the holding module comprises coupling the dosing module to the coupled unit.
